(19) United States
(12) Patent Application Publication
(10) Pub. No.: US 2020/0042852 A1
(43) Pub. Date: Feb. 6, 2020

(54) RFID TAG AND METHOD OF MANUFACTURING THE SAME

(71) Applicant: Murata Manufacturing Co., Ltd., Nagaokakyo-shi (JP)

(72) Inventors: Ryohei Omori, Nagaokakyo-shi (JP); Noboru Kato, Nagaokakyo-shi (JP)

(21) Appl. No.: 16/599,191

(22) Filed: Oct. 11, 2019

Related U.S. Application Data
(63) Continuation of application No. PCT/JP2018/015544, filed on Apr. 13, 2018.

(30) Foreign Application Priority Data
Apr. 18, 2017 (JP) 2017-082269

(51) Int. Cl. G06K 19/077

(52) U.S. Cl. CPC G06K 19/07722; G06K 19/07724; G06K 19/07773

(57) ABSTRACT

An RFID tag is provided that has a rectangular parallelepiped substrate including a top surface, a bottom surface, and four side surfaces, an RFIC chip mounted on the top surface of the substrate, and a coil conductor connected to the RFIC chip. The coil conductor includes a conductor pattern disposed on the top surface, a conductor pattern disposed on the bottom surface, and a plurality of through-hole conductors penetrating the substrate and extending between the top and bottom surfaces. Moreover, a winding axis of the conductor pattern intersects with each of a pair of the side surfaces opposite to each other and having a largest area among the four side surfaces.

### CROSS REFERENCE TO RELATED APPLICATIONS

The present application is a continuation of PCT/JP2018/015544 filed Apr. 13, 2018, which claims priority to Japanese Patent Application No. 2017-082269, filed Apr. 18, 2017, the entire contents of each of which are incorporated herein by reference.

### TECHNICAL FIELD

The exemplary embodiments of the present invention relate to an RFID tag and a method of manufacturing the same.

### BACKGROUND

In general, an RFID tag described in Patent Document 1 (identified below) is known as a small RFID (Radio-Frequency IDentification) tag that includes a coil conductor functioning as an antenna. The RFID tag described in Patent Document 1 has a plurality of metal posts that are portions of coil conductors disposed vertically on a substrate on which an RFIC chip is mounted in order to provide favorable communication characteristics.
Patent Document 1: WO 2016/031408.

However, in the case of the RFID tag described in Patent Document 1, the manufacturing process is complicated since it is necessary to vertically dispose a plurality of elongated metal posts closely on the substrate. As a result, the manufacturing cost of the RFID tag is increased.

### SUMMARY OF THE INVENTION

Therefore, the exemplary embodiments of the present invention are to provide an RFID tag having favorable communication characteristics as well as a structure that can be easily manufactured.

Thus, to solve the technical problems described above, an exemplary aspect of the present invention provides an RFID tag comprising a rectangular parallelepiped substrate including a top surface, a bottom surface, and four side surfaces; an RFIC chip mounted on the top surface of the substrate; and a coil conductor disposed on the substrate and connected to the RFIC chip. Moreover, the coil conductor includes a conductor pattern disposed on the top surface, a conductor pattern disposed on the bottom surface, and a plurality of through-hole conductors penetrating the substrate and extending between the top surface and the bottom surface. In addition, a winding axis of the coil conductor intersects with each of paired side surfaces opposite to each other and has a largest area among the four side surfaces.

Another exemplary aspect of the present invention provides a method of manufacturing an RFID tag that includes preparing a collective substrate including a principal surface and a back surface at both ends in a thickness direction and including a plurality of rectangular parallelepiped child substrate regions; forming a conductor pattern on a principal surface portion of each of the child substrate regions; forming a conductor pattern on a back surface portion of each of the child substrate regions; forming a plurality of through-holes penetrating the collective substrate in the thickness direction and extending between the principal surface and the back surface in each of the child substrate regions; disposing a plurality of through-hole conductors by forming conductor layers on inner surfaces of the plurality of through-holes, and thereby forming a coil conductor including the respective conductor patterns of the principal surface portion and the back surface portion and the plurality of through-hole conductors, in each of the child substrate regions; mounting an RFIC chip connected to the coil conductor on the principal surface portion of each of the child substrate regions; and producing a plurality of rectangular parallelepiped RFID tags by cutting the collective substrate along boundaries of the plurality of child substrate regions. Moreover, according to this exemplary aspect, the collective substrate is cut such that a winding axis of the coil conductor intersects with each of paired cutting surfaces opposite to each other and has a largest area among four cutting surfaces of the RFID tag.

According to the exemplary embodiments of the present invention, the RFID tag having favorable communication characteristics and that has a structure that can be easily manufactured.

### BRIEF DESCRIPTION OF DRAWINGS

FIG. 1 is a perspective view showing a configuration of an RFID tag according to a first exemplary embodiment of the present invention.

FIG. 2 is a cross-sectional view of the RFID tag shown in FIG. 1.

FIG. 3A is a perspective view for explaining a step of a method of manufacturing an example of the RFID tag shown in FIG. 1.

FIG. 3B is a perspective view for explaining a step following the step shown in FIG. 3A.

FIG. 3C is a perspective view for explaining a step following the step shown in FIG. 3B.

FIG. 3D is a perspective view for explaining a step following the step shown in FIG. 3C.

FIG. 4 is a perspective view showing a configuration of an RFID tag according to a second exemplary embodiment.

FIG. 5 is a perspective view showing a configuration of a modification of the RFID tag according to the second exemplary embodiment.

FIG. 6 is a perspective view showing a configuration of an RFID tag according to a third exemplary embodiment.

FIG. 7 is a perspective view showing a configuration of an RFID tag according to a fourth exemplary embodiment.

FIG. 8 is a perspective view showing a configuration of an RFID tag according to a fifth exemplary embodiment.

FIG. 9 is a perspective view showing a configuration of an RFID tag according to a sixth exemplary embodiment.

FIG. 10 is a plan view of the RFID tag shown in FIG. 9.

FIG. 11 is a plan view of an RFID tag according to a seventh exemplary embodiment.

FIG. 12 is a plan view of an RFID tag according to an eighth exemplary embodiment.

FIG. 13 is a plan view of an RFID tag according to a ninth exemplary embodiment.

FIG. 14 is a plan view of an RFID tag according to a tenth exemplary embodiment.

FIG. 15 is a plan view of an RFID tag according to an eleventh exemplary embodiment.

FIG. 16 is a plan view of an RFID tag of an example according to a twelfth exemplary embodiment.

FIG. 17 is a plan view of an RFID tag of another example according to a thirteenth exemplary embodiment.

FIG. 18 is a plan view of an RFID tag of a further example according to a fourteenth exemplary embodiment.

### DETAILED DESCRIPTION

An exemplary aspect of the present invention provides an RFID tag that includes a rectangular parallelepiped substrate including a top surface, a bottom surface, and four side surfaces; an RFIC chip mounted on the top surface of the substrate; and a coil conductor disposed on the substrate and connected to the RFIC chip, wherein the coil conductor includes a conductor pattern disposed on the top surface, a conductor pattern disposed on the bottom surface, and a plurality of through-hole conductors penetrating the substrate and extending between the top surface and the bottom surface, and wherein a winding axis of the coil conductor intersects with each of paired side surfaces opposite to each other and having a largest area among the four side surfaces.

According to this exemplary aspect, the RFID tag is provided to have favorable communication characteristics as well as a structure that can be easily manufactured.

According to an exemplary aspect, each of the paired side surfaces intersected by the winding axis of the coil conductor can have a larger area as compared to the top surface and the bottom surface. This prevents the substrate from deforming such that the top and bottom surfaces are significantly curved and prevents damage to the RFIC chip and the conductor pattern on the top and bottom surfaces.

Moreover, a first protective layer covering the RFIC chip and the conductor pattern can be disposed on the top surface. This protects the RFIC chip and the conductor pattern on the top surface.

In addition, a second protective layer covering the conductor pattern can be disposed on the bottom surface. This protects the conductor pattern on the bottom surface.

If the first and second protective layers are resin layers of the same resin material, the RFID tag can further be provided with resin connection bodies of the same resin material extending in the through-hole conductors to connect the first protective layer and the second protective layer. As a result, the first and second protective layers are integrated, the rigidity of the RFID tag against deformation is improved, and the protective layers are prevented from peeling.

If the coil conductor comprises at least two loops so that the number of the included through-hole conductors is at least four, the through-hole conductors included in one loop may overlap with the through-hole conductors included in another loop adjacent to the one loop when viewed in an opposing direction of a pair of the side surfaces different from a pair of the side surfaces of the substrate intersected by the winding axis. As a result, the size of the RFID tag can be reduced in the winding axis direction of the coil conductor.

In an exemplary aspect, the substrate may be a glass epoxy substrate to improve the heat resistance of the RFID tag.

In an exemplary aspect, the RFID tag further comprises a booster antenna; the booster antenna includes a sheet-shaped antenna base material on which the RFID tag is mounted via one of the paired side surfaces intersected by the winding axis of the coil conductor, and an antenna conductor disposed on the antenna base material; and the antenna conductor includes a coupling part coupled through an electromagnetic field to the coil conductor and a radiation part extending from the coupling part. This configuration extends the communication distance of the RFID tag.

Moreover, the coupling part of the antenna conductor can be loop-shaped or semi-loop-shaped, and the coil conductor can be disposed in the loop-shaped or semi-loop-shaped coupling part. As a result, the coupling part is prevented from being broken due to an edge of the RFID tag.

The coupling part of the antenna conductor can be loop-shaped or semi-loop-shaped, and the RFID tag can be disposed on the antenna base material so that the coil conductor overlaps with the loop-shaped or semi-loop-shaped coupling part. As a result, the coupling part of the antenna conductor and the coil conductor of the RFID tag are more strongly coupled through an electromagnetic field, and consequently, the communication distance of the RFID tag is further extended.

The coupling part of the antenna conductor can further be made up of a semi-loop-shaped conductor disposed on one surface of the antenna base material and a capacitance-forming conductor disposed on the other surface of the antenna base material and capacitively coupled to one end and the other end of the semi-loop-shaped conductor. This leads to a configuration of the loop-shaped coupling part hardly broken even if the antenna base material is significantly and repeatedly deformed. Additionally, the resonance frequency of the antenna conductor and the resonance frequency of the RFID tag can be made substantially equal, so that the coupling part of the antenna conductor and the coil conductor of the RFID tag are more strongly coupled through an electromagnetic field. Consequently, the communication distance of the RFID tag is further extended.

In one exemplary aspect, the antenna base material can be a cloth member, and the antenna conductor may be a conducting wire sewn to the cloth member. As a result, the freely deformable RFID tag with a booster antenna can be achieved.

Another aspect of the present invention provides a method of manufacturing an RFID tag that includes preparing a collective substrate including a principal surface and a back surface at both ends in a thickness direction and including a plurality of rectangular parallelepiped child substrate regions; forming a conductor pattern on a principal surface portion of each of the child substrate regions; forming a conductor pattern on a back surface portion of each of the child substrate regions; forming a plurality of through-holes penetrating the collective substrate in the thickness direction and extending between the principal surface and the back surface in each of the child substrate regions; disposing a plurality of through-hole conductors by forming conductor layers on inner surfaces of the plurality of through-holes, and thereby forming a coil conductor including the respective conductor patterns of the principal surface portion and the back surface portion and the plurality of through-hole conductors, in each of the child substrate regions; mounting an RFIC chip connected to the coil conductor on the principal surface portion of each of the child substrate regions; and producing a plurality of rectangular parallelepiped RFID tags by cutting the collective substrate along boundaries of the plurality of child substrate regions, wherein the collective substrate is cut such that a winding axis of the coil conductor intersects with each of paired cutting surfaces opposite to each other and having a largest area among four cutting surfaces of the RFID tag.

According to this exemplary aspect, the RFID tag is provided having favorable communication characteristics as well as a structure that can be easily manufactured.

### First Exemplary Embodiment

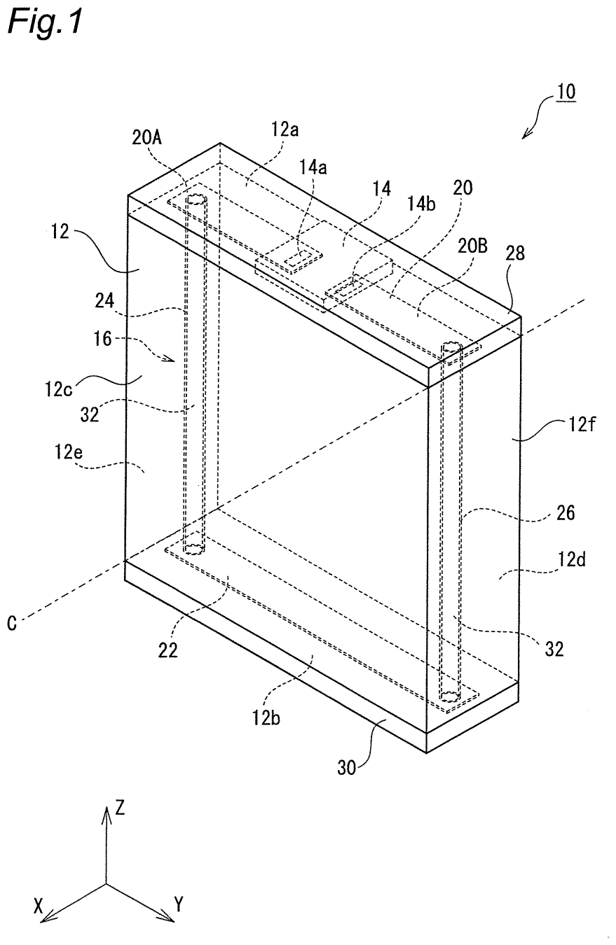

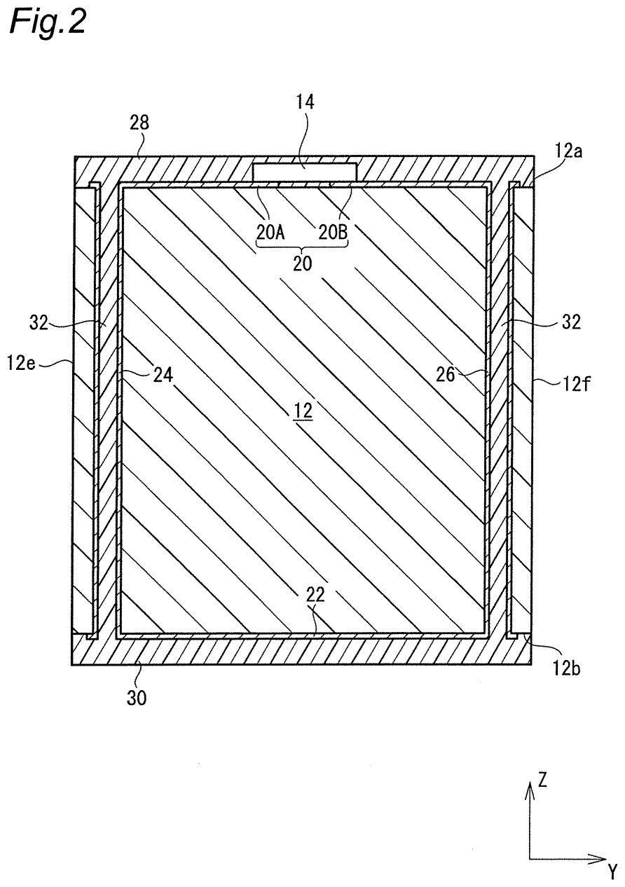

FIG. 1 is a perspective view showing a configuration of an RFID (RFID (i.e., “Radio-Frequency Identification”)) tag according to a first embodiment of the present invention, and FIG. 2 is a cross-sectional view of the RFID tag. An X-Y-Z coordinate system shown in the figures is for facilitating understanding of the invention, but it is noted that the exemplary coordinate system does not limit the invention.

As shown in FIG. 1, the RFID tag 10 has a rectangular parallelepiped substrate 12, and the substrate 12 is provided with an RFIC chip 14 and a coil conductor 16.

As described in detail below, the substrate 12 is produced by cutting a glass epoxy substrate having high heat resistance into multiple pieces, for example. The substrate 12 has a rectangular parallelepiped shape and includes a top surface 12a, a bottom surface 12b, and four side surfaces 12c, 12d, 12e, 12f. The top surface 12a and the bottom surface 12b are opposite surfaces in a Z-axis direction, the side surface 12c and the side surface 12d are opposite surfaces in an X-axis direction, and the side surface 12e and the side surface 12f are opposite surfaces in a Y-axis direction. A pair of the side surfaces 12c, 12d opposite to each other has a larger area as compared to a pair of the side surfaces 12e, 12f opposite to each other and therefore has the largest area among the four side surfaces.

The RFIC chip 14 is configured to perform wireless communication at a predetermined communication frequency (e.g., a frequency in the UHF band) and includes first and second input/output terminals 14a, 14b for connection to an antenna (generally referred to as an “coil conductor”).

The coil conductor 16 connected to the RFIC chip 14 includes a top-surface conductor pattern 20 disposed on the top surface 12a of the substrate 12, a bottom-surface conductor pattern 22 disposed on the bottom surface 12b of the substrate 12, and first and second through-hole conductors 24, 26 penetrating the substrate 12.

Specifically, the top-surface conductor pattern 20 is made up of two sub-conductor patterns 20A, 20B disposed on the top surface 12a of the substrate 12. The one sub-conductor pattern 20A has one end connected to the first input/output terminal 14a of the RFIC chip 14 and extends toward the side surface 12e of the substrate 12. The other sub-conductor pattern 20B has one end connected to the second input/output terminal 14b of the RFIC chip 14 and extends toward the side surface 12f of the substrate 12.

As further shown, the bottom-surface conductor pattern 22 is disposed on the bottom surface 12b of the substrate 12 to extend in the opposing direction (Y-axis direction) of the side surface 12e and the side surface 12f.

The first through-hole conductor 24 penetrates the substrate 12 and extends between the top surface 12a and the bottom surface 12b. This allows the first through-hole conductor 24 to connect the other end of the one sub-conductor pattern 20A in the top-surface conductor pattern 20 and one end of the bottom-surface conductor pattern 22 (an end on the side surface 12e side).

The second through-hole conductor 26 penetrates the substrate 12 and extends between the top surface 12a and the bottom surface 12b. This allows the second through-hole conductor 26 to connect the other end of the other sub-conductor pattern 20B in the top-surface conductor pattern 20 and the other end of the bottom-surface conductor pattern 22 (an end on the side surface 12f side).

According to the exemplary embodiment, the coil conductor 16 including the top-surface conductor pattern 20, the bottom-surface conductor pattern 22, the first through-hole conductor 24, and the second through-hole conductor 26 has a winding axis C intersecting with each of the paired opposite side surfaces 12c, 12d of the substrate 12.

According to the first exemplary embodiment, the first through-hole conductor 24 and the second through-hole conductor 26 extend parallel to each other in the opposing direction (Z-axis direction) of the top surface 12a and the bottom surface 12b. The first through-hole conductor 24 and the second through-hole conductor 26 overlap when viewed in the opposing direction (Y-axis direction) of the side surface 12e and the side surface 12f. Therefore, the winding axis C of the coil conductor 16 is orthogonal to each of the side surfaces 12c, 12d.

In the first embodiment, for protecting the RFIC chip 14 and the top-surface conductor pattern 20 of the coil conductor 16, a first protective layer 28 is disposed on the top surface 12a of the substrate 12 to cover the RFIC chip 14 and the top-surface conductor pattern 20. Similarly, for protecting the bottom-surface conductor pattern 22 of the coil conductor 16, a second protective layer 30 is disposed on the bottom surface 12b of the substrate 12 to cover the bottom-surface conductor pattern 22. In the case of the first embodiment, the first and second protective layers 28, 30 are resin layers of the same resin material, for example, an epoxy resin material.

As shown in FIG. 2, the first protective layer 28 and the second protective layer 30 are connected and integrated by resin connectors 32 of the same resin material extending in the first and second through-hole conductors 24, 26. As a result, the rigidity of the RFID tag 10 against deformation is improved, and the first and second protective layers 28, 30 are prevented from peeling from the substrate 12.

In an exemplary aspect, if the conductor patterns 20, 22 are patterned by etching, the first and second protective layers 28, 30 are preferably made of the same material as the resist layer thereof. By integrating the protective layer and the resist layer, the rigidity of the RFID tag 10 against deformation is further improved, and the protective layers are further prevented from peeling.

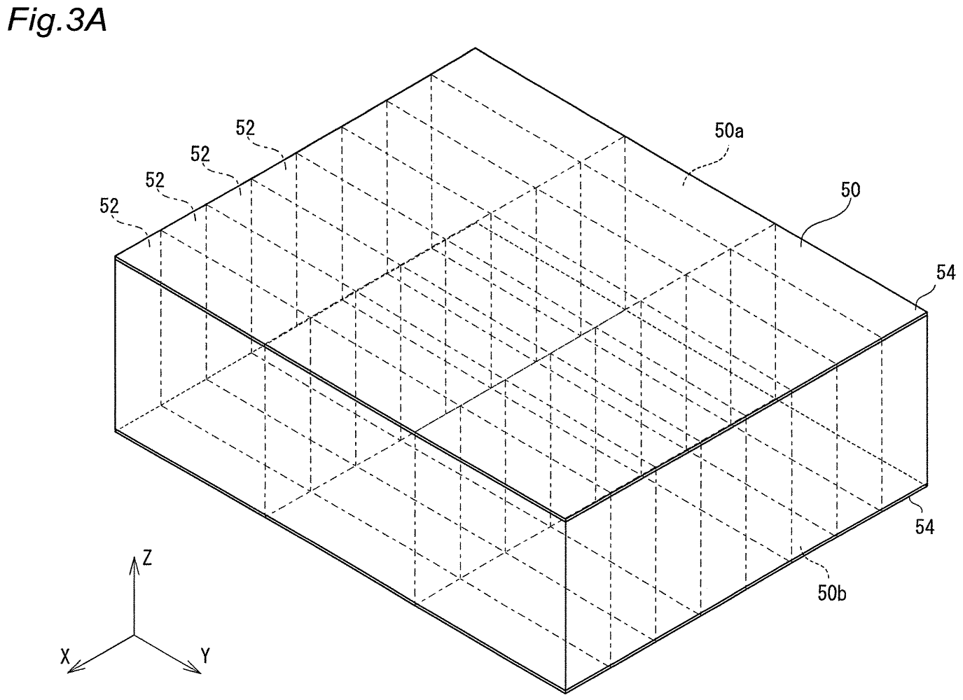

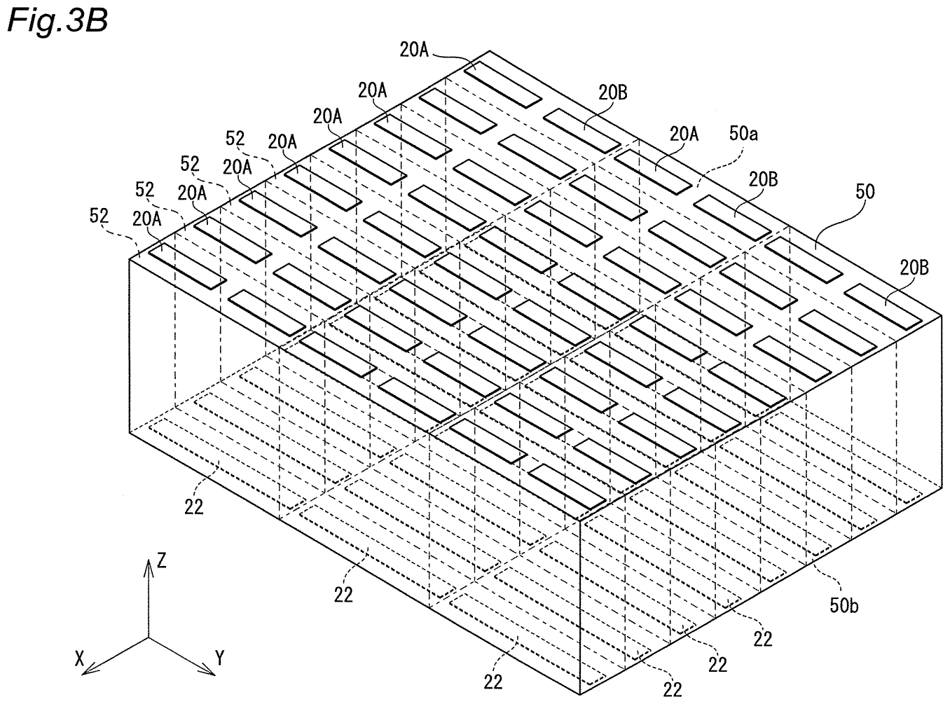

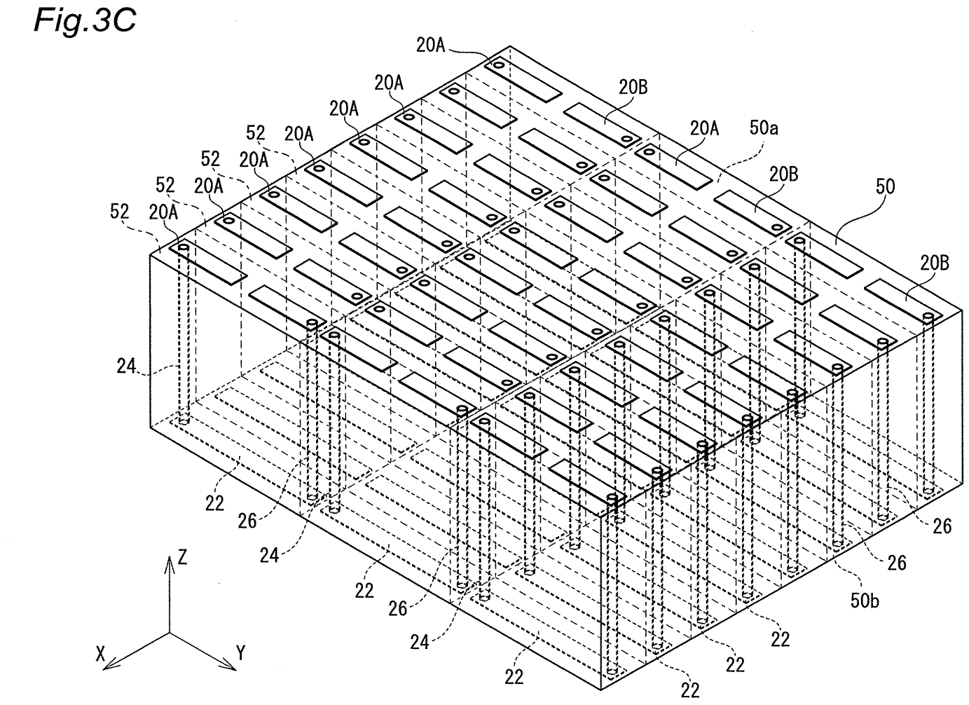

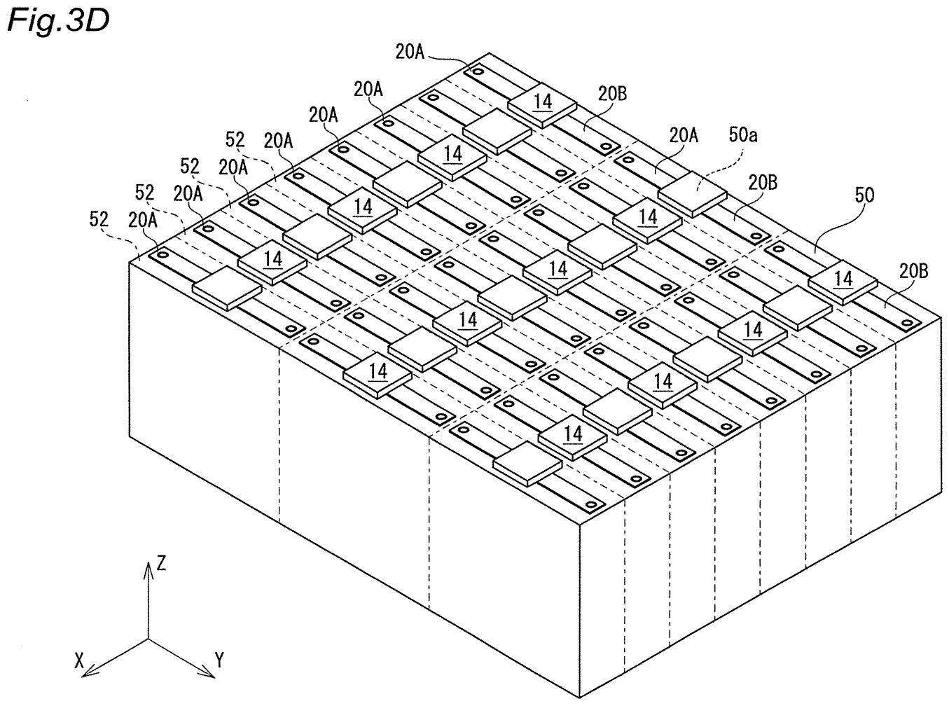

A method of manufacturing the RFID tag 10 as described above will be described with reference to FIGS. 3A to 3D.

First, as shown in FIG. 3A, for example, a collective substrate 50 such as a glass epoxy substrate is prepared. The collective substrate 50 has a principal surface 50a and a back surface 50b at both ends in the thickness direction (Z-axis direction) and includes a plurality of rectangular parallelepiped child substrate regions (regions each turned into the substrate 12 of the RFIC chip 10) 52. In the case of the first embodiment, conductor layers 54 of copper etc. are formed entirely on the principal surface 50a and the back surface 50b of the collective substrate 50.

As shown in FIG. 3B, the conductor layer 54 on the principal surface 50a of the collective substrate 50 is partially removed by etching etc., to form the sub-conductor patterns 20A, 20B in a plurality of the top-surface conductor patterns 20. As a result, the top-surface conductor pattern 20 (the sub-conductor patterns 20A, 20B) is formed in each of the plurality of the child substrate regions 52.

Similarly, the conductor layer 54 on the back surface 50b of the collective substrate 50 is partially removed by etching etc. to form a plurality of the bottom-surface conductor patterns 22. As a result, the bottom-surface conductor pattern 22 is formed in each of the plurality of the child substrate regions 52.

As shown in FIG. 3C, through-holes penetrating the top-surface conductor pattern 20 (the sub-conductor patterns 20A, 20B), the bottom-surface conductor patterns 22, and the collective substrate 50 are then formed in each of the plurality of the child substrate regions 52 of the collective substrate 50. The through-holes are formed, for example, by punching the collective substrate 50 with punching pins.

After the through-holes are formed, the inner surfaces thereof are plated with nickel, copper, etc. to form conductor layers on the inner surfaces. As a result, the first and second through-hole conductors 24, 26 are formed. Consequently, the coil conductor 16 is formed in each of the plurality of the child substrate regions 52.

Subsequently, as shown in FIG. 3D, a plurality of RFIC chips 14 is mounted on the principal surface 50a of the collective substrate 50 and thereby respectively connected to the coil conductors 16 of the plurality of the child substrate regions 52 of the collective substrate 50.

Subsequently, a protective layer (e.g., resin layer) covering the plurality of the RFIC chips 14 and the plurality of the top-surface conductor patterns 20 (e.g., the sub-conductor patterns 20A, 20B) is formed entirely on the principal surface 50a of the collective substrate 50. Similarly, a resin layer covering the plurality of the bottom-surface conductor patterns 22 is formed entirely on the back surface 50b of the collective substrate 50. At this step, the resin material is also filled in the first and second through-hole conductors 24, 26, and the resin connectors 32 are thereby formed. The collective substrate 50 is then cut along boundaries of the plurality of the child substrate regions 52 so that the plurality of the RFID tags 10 shown in FIG. 1 is produced. At this step, the collective substrate 50 is cut such that the winding axes C of the coil conductors 16 respectively intersect with paired opposite cutting surfaces (i.e., the side surfaces 12c, 12d) having the largest area among the four cutting surfaces of the RFID tags 10 (i.e., four side surfaces 12c, 12d, 12e, 12f of the substrate 12).

According to the RFID tag 10 as described above, the coil conductor 16 are configured to function as an antenna. The RFIC chip 14 wirelessly communicates with a reader/writer device (not shown) via the coil conductor 16 functioning as an antenna. For example, when the coil conductor 16 receives a radio wave from the reader/writer device, a current flows from the coil conductor 16 to the RFIC chip 14, and the RFIC chip 14 is activated. The activated RFIC chip 14 supplies the coil conductor 16 with a current signal corresponding to information stored in an internal storage part. The coil conductor 16 then generates a radio wave, and the radio wave is received by the reader/writer device.

To obtain desired communication characteristics, e.g., to make the resonance frequency of the RFID tag 10 substantially identical to the communication frequency thereof, the length of the first and second through-hole conductors 24, 26 in the coil conductor 16, i.e., the thickness of the collective substrate 50 (the distance from the principal surface 50a to the back surface 50b), is determined. Specifically, a resonance circuit is formed by the internal capacitance of the RFIC chip 14, the inductance of the conductor patterns 20, 22, and the inductance of the first and second through-hole conductors 24, 26. The length of the first and second through-hole conductors 24, 26 is determined such that the resonance frequency of the resonance circuit is substantially identical to the communication frequency of the RFID tag 10. From another point of view, by using collective substrates having different thicknesses, the resonance frequency can be changed, and consequently, RFID tags having different communication frequencies can be achieved. In addition to or instead of changing the length of the through-hole conductors, the shapes etc. of the conductor patterns 20, 22 can be changed to change the resonance frequency.

As shown in FIG. 1, the winding axis C of the coil conductor 16 intersects with the paired opposite side surfaces 12c, 12d having the largest area among the four side surfaces 12c, 12d, 12e, 12f of the substrate 12. In the first embodiment, since the areas of side surfaces 12c, 12d are larger than the areas of the top surface 12a and the bottom surface 12b, the winding axis C of the coil conductor 16 intersects with the side surface 12c or 12d having the largest area in the substrate 12. Therefore, a coil opening of the coil conductor 16 is disposed to be as large as possible in the substrate 12. This enables the RFID tag 10 to make the communication distance as large as possible in a predetermined volume (e.g., a required size) (as compared to when the winding axis of the coil conductor intersects with other surfaces).

Furthermore, as shown in FIG. 1, the RFIC chip 14 is present on the outside of the coil conductor 16 when viewed in the direction of the winding axis C of the coil conductor 16 (e.g., an X-axis direction), and therefore, the RFIC chip 14 is prevented from affecting the magnetic field generated by the coil conductor 16. In contrast, if the RFIC chip 14 is present on the inside of the coil conductor 16, a metal member (conductor) in the RFIC chip 14 may interfere with the magnetic flux passing through the inside, for example. Consequently, a communicable distance of wireless communication using the coil conductor 16 may be shortened. By disposing the RFIC chip 14 on the outside of the coil conductor 16 so that such an influence on the magnetic field is suppressed, the RFID tag 10 can obtain stable communication characteristics.

Furthermore, the RFIC chip 14 is mounted on the top surface 12a that is not the surface having the largest area in the substrate 12. Deflection of the substrate 12 occurs such that the surface having the largest area is curved. Therefore, the RFIC chip 14 mounted on the top surface 12a is hardly damaged even if the deflection occurs in the substrate 12. Connection parts (e.g., solder connection parts) between the RFIC chip 14 and the coil conductor 16 are hardly broken. This enables the RFID tag 10 to maintain desired communication characteristics.

Additionally, as shown in FIG. 1, the RFIC chip 14 protected by the protective layers 28, 30, the top-surface conductor pattern 20, and the bottom-surface conductor pattern 22 are formed on the top surface 12a and the bottom surface 12b that are not the surface having the largest area in the substrate 12. Therefore, as compared to when the RFIC chip 14 etc. to be protected are disposed on the surface having the largest area, a smaller amount of resin is required for forming the protective layers. Since a smaller amount of resin is required, i.e., the resin layers have a smaller volume, the thermal expansion of the resin layers is suppressed to a smaller amount. Advantageously, this prevents a damage that may occur due to thermal expansion of the resin layers to the RFIC chip 14 and the conductor patterns 20, 22 covered with the resin layers. Consequently, the RFID tag 10 can continuously maintain the desired communication characteristics.

Additionally, according to the structure of the RFID tag 10 as described above, since portions of the coil conductor 16 are the through-hole conductors 24, 26, the RFID tag 10 (i.e., the coil conductor 16) is easily manufactured (as compared to when metal posts are used instead of the through-hole conductors). Specifically, the manufacturing is facilitated as compared to when multiple elongated metal posts having the same length and the same diameter as the through-hole conductors 24, 26 are maintained parallel to each another and vertically disposed on the substrate. Therefore, the RFID tag 10 according to the first embodiment can be manufactured at a lower manufacturing cost than the manufacturing cost of the RFID tag in which portions of the coil conductor are metal posts.

Additionally, as compared to when the coil conductors of the plurality of RFID tags are formed as conductor patterns on the principal surface of the collective substrate, a larger number of the RFID tags 10 according to the first embodiment can be produced from the collective substrate having the same size. Therefore, the material cost of the RFID tag 10 can be kept low, and consequently, the manufacturing cost of the RFID tag 10 can be kept low.

According to the first embodiment as described above, the RFID tag having favorable communication characteristics as well as a structure that can be easily manufactured.

### Second Exemplary Embodiment

An RFID tag of a second embodiment is different from the RFID tag 10 of the first embodiment in that a capacitor chip is included. Therefore, the second embodiment will be described mainly in terms of different points.

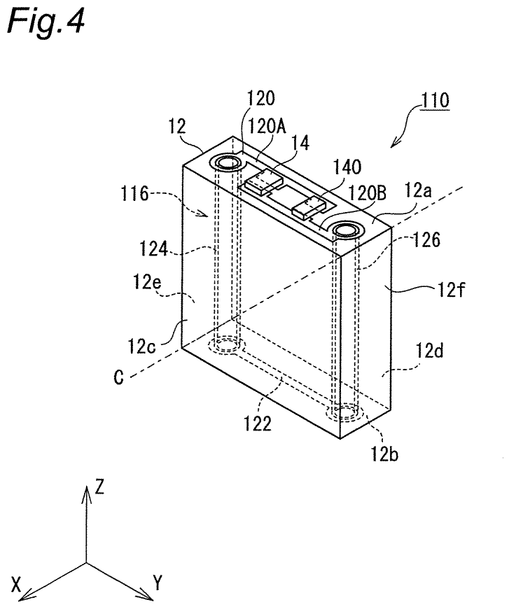

FIG. 4 is a perspective view showing a configuration of the RFID tag according to the second embodiment. It is noted that the same reference numerals are given to constituent elements that are substantially the same as the constituent elements of the first embodiment. The protective layers are not shown in the figure.

As shown in FIG. 4, an RFID tag 110 of the second embodiment includes a capacitor chip 140 mounted together with the RFIC chip 14 on the top surface 12a of the substrate 12. The RFIC chip 14 and the capacitor chip 140 are arranged parallel to a coil conductor 116. Thus, a resonance circuit is made up of the internal capacitance of the RFIC chip 14, the capacitance of the capacitor chip 140, the inductance of the coil conductor 116 (inductance of conductor patterns 120, 122 and first and second through-hole conductors 124, 126). The capacitance of the capacitor chip 140 and the length of the first and second through-hole conductors 124, 126 are determined such that the resonance frequency of the resonance circuit is substantially identical to the communication frequency of the RFID tag 10.

In the case of the first embodiment described above, once the communication frequency of the RFID tag 10 is determined, the length (i.e., inductance) of the first and second through-hole conductors 124, 126 required for obtaining the resonance frequency substantially the same as the communication frequency is uniquely determined. Therefore, the degree of freedom in design of the RFID tag 10 is low. For example, the overall size of the RFID tag 10 is limited.

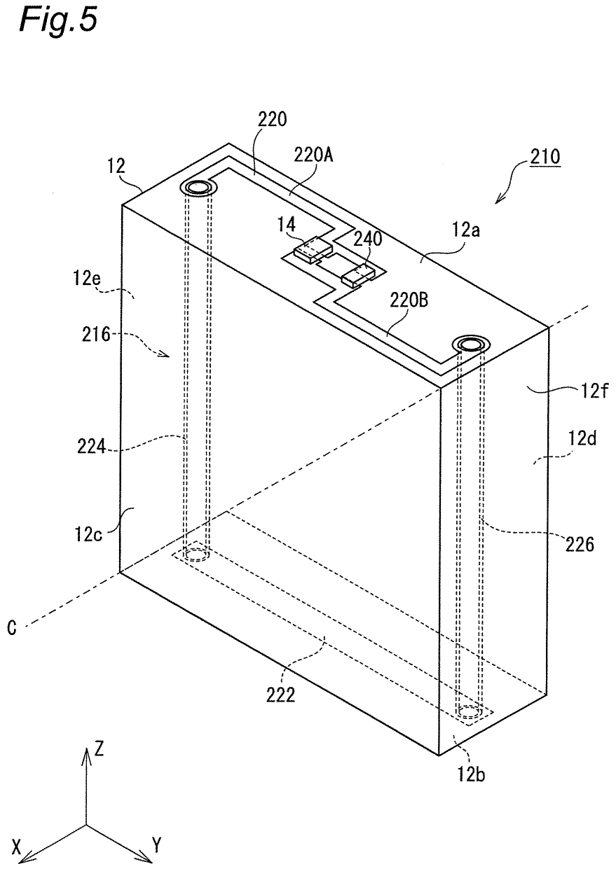

In contrast, in the case of the second embodiment, even if the communication frequency of the RFIC tag 110 is determined, the length of the first and second through-hole conductors 124, 126 is not uniquely determined. Specifically, the length of the first and second through-hole conductors 124, 126 differs depending on the capacitance of the capacitor chip 140. Therefore, for example, as shown in FIG. 5 showing an RFID tag 210 of a modification of the second embodiment, by using a capacitor chip 240 different from the capacitor chip 140 in capacitance, first and second through-hole conductors 224, 226 can have length different from the length of the first and second through-hole conductors 124, 126 shown in FIG. 4 (e.g., a coil conductors 216 having a different size can be achieved). As described above, by using the capacitor chip, the RFID tag can be designed with a high degree of freedom so that favorable communication characteristics can be obtained. Consequently, an RFID tag structure is provided that can be easily manufactured.

According to the second embodiment, as in the first embodiment described above, the RFID tag having favorable communication characteristics as well as a structure that can be easily manufactured.

### Third Exemplary Embodiment

In the case of the second embodiment described above, as shown in FIG. 4, the coil conductor 116 is made up of one loop. In contrast, an RFID tag according to a third embodiment is made up of two loops. Therefore, the third embodiment will be described mainly in terms of different points.

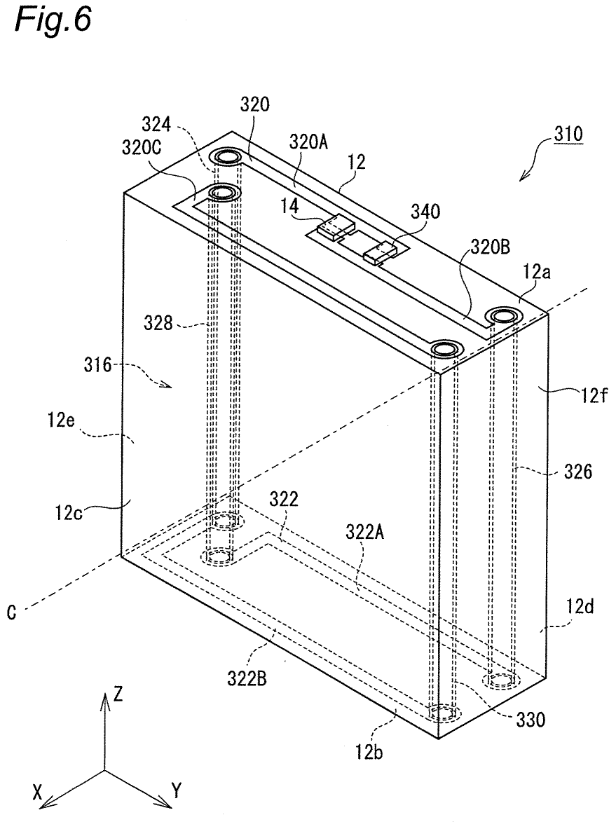

FIG. 6 is a perspective view showing a configuration of the RFID tag according to the third embodiment. It is noted that the same reference numerals are given to constituent elements that are substantially the same as the constituent elements of the first embodiment. The protective layers are not shown in the figure.

As shown in FIG. 6, in an RFID tag 310 of the third embodiment, a coil conductor 316 is made up of two loops.

Specifically, a top-surface conductor pattern 320 on the top surface 12a of the substrate 12 is made up of three sub-conductor patterns 320A, 320B, 320C. A bottom-surface conductor pattern 322 on the bottom surface 12b of the substrate 12 is made up of two sub-conductor patterns 322A, 322B. Furthermore, four first to fourth through-hole conductors 324, 326, 328, 330 penetrate the substrate 12 and extend between the top surface 12a and the bottom surface 12b.

On the top surface 12a of the substrate 12, the sub-conductor pattern 320A is connected to the RFIC chip 14 and a capacitor chip 340 on one end side and is connected to the first through-hole conductor 324 on the other end side. The sub-conductor pattern 320B is connected to the RFIC chip 14 and the capacitor chip 340 on one end side and is connected to the second through-hole conductor 326 on the other end side. The sub-conductor pattern 320C is connected to the third through-hole conductor 328 on one end side and is connected to the fourth through-hole conductor 330 on the other end side.

On the bottom surface 12b of the substrate 12, the sub-conductor pattern 322A is connected to the third through-hole conductor 328 on one end side and is connected to the second through-hole conductor 326 on the other end side. The sub-conductor pattern 322B is connected to the first through-hole conductor 324 at on one end side and is connected to the fourth through-hole conductor 330 on the other end side.

The coil conductor 316 of the third embodiment made up of two loops configured to generate a magnetic field having a higher strength as compared to a coil conductor made up of one loop. Therefore, the RFID tag 310 can perform wireless communication over a longer communication distance as a favorable communication characteristic as compared to an RFID tag using the one-loop coil conductor as an antenna.

According to the third embodiment, as in the first embodiment described above, the RFID tag having favorable communication characteristics as well as a structure that can be easily manufactured.

### Fourth Exemplary Embodiment

In the case of the RFID tag 310 according to the third embodiment described above, since the coil conductor 316 is made up of two loops, the RFID tag 310 has a larger size in the winding axis C direction as compared to the RFID tag including the one-loop coil conductor. Therefore, an RFID tag of a fourth embodiment includes a two-loop coil conductor and is made as small as possible in the size in the winding axis direction of the coil conductor.

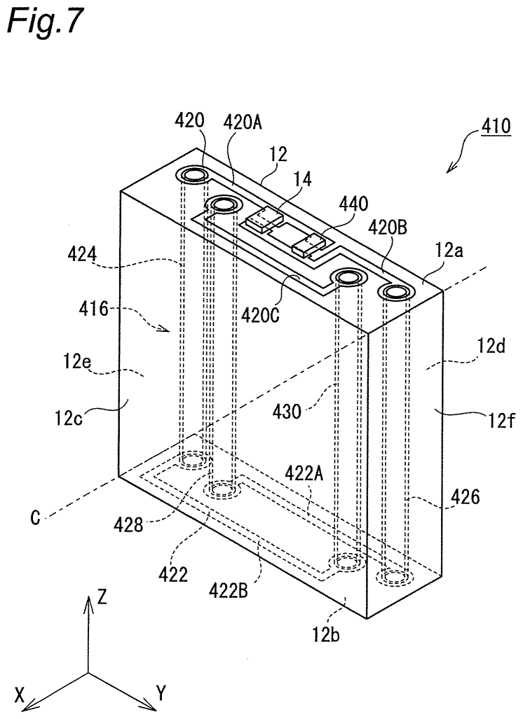

FIG. 7 is a perspective view showing a configuration of the RFID tag according to the fourth embodiment. It is noted that the same reference numerals are given to constituent elements that are substantially the same as the constituent elements of the first embodiment. The protective layers are not shown in the figure.

As shown in FIG. 7, in an RFID tag 410 of the fourth embodiment, a coil conductor 416 is made up of two loops. The coil conductor 416 is made up of a top-surface conductor pattern 420 (e.g., sub-conductor patterns 420A, 420B, 420C), a bottom-surface conductor pattern 422 (e.g., sub-conductor patterns 422A, 422B), and first to fourth through-hole conductors 424, 426, 428, 430.

As shown in FIG. 7, when viewed in the opposing direction (e.g., the Y-axis direction) of the pair of the side surfaces 12e, 12f different from the pair of the side surfaces 12c, 12d intersecting with the winding axis C of the coil conductor 416, the through-hole conductors 424, 426, 428, 430 are at least partially overlap. Specifically, the third and fourth through-hole conductors 428, 430 forming a second loop partially overlap with the first and second through-hole conductors 424, 426 forming a first loop.

Such overlapping of the through-hole conductors can reduce the size of the RFID tag 410 in the winding axis C direction of the coil conductor 416.

According to the fourth embodiment, as in the first embodiment described above, the RFID tag having favorable communication characteristics as well as a structure that can be easily manufactured.

### Fifth Exemplary Embodiment

A fifth embodiment is an improved form of the fourth embodiment described above. Therefore, the fifth embodiment will be described mainly in terms of different points.

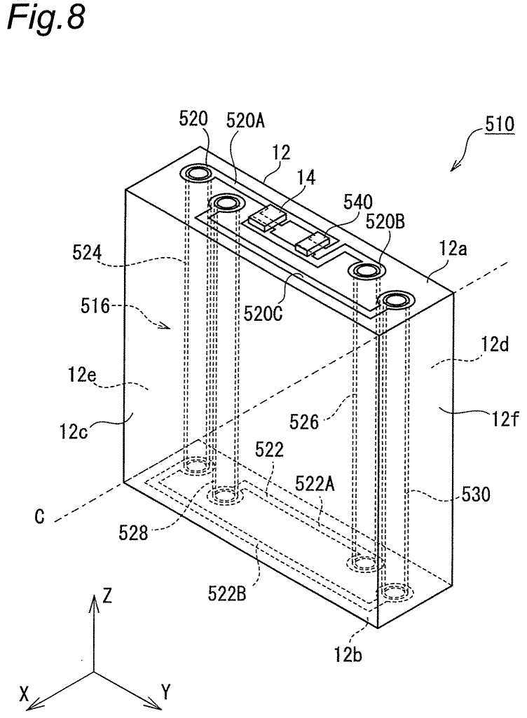

FIG. 8 is a perspective view showing a configuration of the RFID tag according to the fifth embodiment. It is noted that the same reference numerals are given to constituent elements that are substantially the same as the constituent elements of the first embodiment. Moreover, the protective layers are not shown in the figure for clarity purposes.

As shown in FIG. 8, in an RFID tag 510 of the fifth embodiment, a coil conductor 516 is made up of two loops. The coil conductor 516 is made up of a top-surface conductor pattern 520 (sub-conductor patterns 520A, 520B, 520C), a bottom-surface conductor pattern 522 (sub-conductor patterns 522A, 522B), and first to fourth through-hole conductors 524, 526, 528, 530.

As shown in FIG. 8, when viewed in the opposing direction (Y-axis direction) of the pair of the side surfaces 12e, 12f different from the pair of the side surfaces 12c, 12d intersecting with the winding axis C of the coil conductor 516, the through-hole conductors 524, 526, 528, 530 are at least partially overlap. Specifically, the third and fourth through-hole conductors 528, 530 forming the second loop partially overlap with the first and second through-hole conductors 524, 526 forming the first loop.

Furthermore, a distance between the first and second through-hole conductors 524, 526 forming the first loop is made substantially equal to a distance between the third and fourth through-hole conductors 528, 530 forming the second loop. Therefore, the loop opening of the first loop and the loop opening of the second loop have substantially the same opening area. As a result, the coil conductor 516 can form a larger magnetic field as compared to the coil conductor 416 of the fourth embodiment described above in which the loop opening of the first loop and the loop opening of the second loop are different. Consequently, the RFID tag 510 of the fifth embodiment using the coil conductor 516 as an antenna can perform wireless communication over a longer communication distance.

According to the fifth embodiment, as in the first embodiment described above, the RFID tag having favorable communication characteristics as well as a structure that can be easily manufactured.

### Sixth Exemplary Embodiment

A sixth embodiment provides an RFID tag according to any one of the first to fifth embodiments described above including a booster antenna so as to obtain more favorable communication characteristics, for example, to extend a communication distance to several meters. In this description, the RFID tag according to the first embodiment described above is taken as an example.

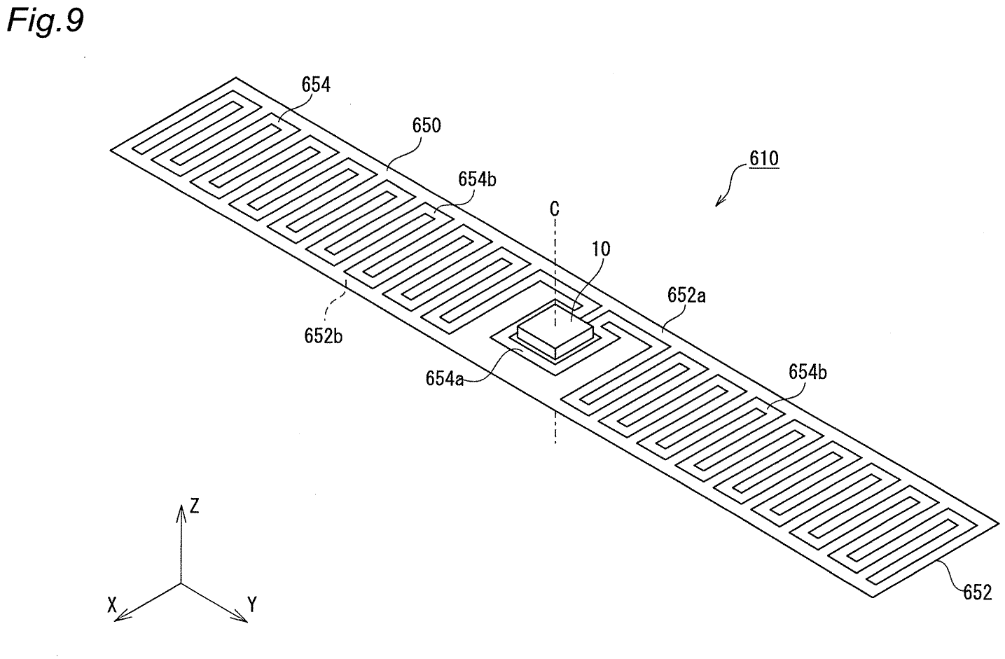

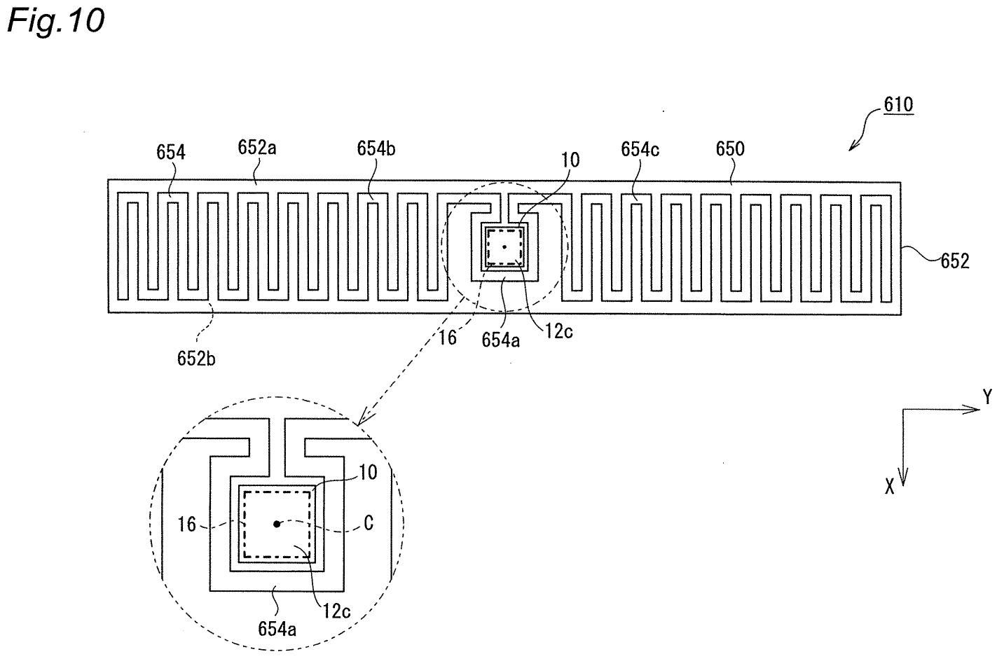

FIG. 9 is a perspective view of an RFID tag with a booster antenna according to the sixth embodiment. FIG. 10 is a plan view of the RFID tag shown in FIG. 9.

As shown in FIGS. 9 and 10, an RFID tag 610 with a booster antenna has an RFID tag 10 and a sheet-shaped booster antenna 650.

The booster antenna 650 includes a sheet-shaped antenna base material 652 made of a resin sheet, for example. An antenna conductor 654 is disposed as a conductor pattern on the antenna base material 652. The RFID tag 10 is mounted on the antenna base material 652. Specifically, as shown in FIG. 1, the RFID tag 10 is mounted on the antenna base material 652 via the side surface 12d (the side surface opposite to the side surface 12c) of the substrate 12 with which the winding axis C of the coil conductor 16 intersects. Therefore, the RFID tag 10 is mounted on the antenna base material 652 such that the winding axis C of the coil conductor 16 intersects with the antenna base material 652. For example, the RFID tag 10 is affixed to the antenna base material 652 by an adhesive.

The antenna conductor 654 has a semi-loop-shaped coupling part 654a coupled through an electromagnetic field to the coil conductor 16 of the RFID tag 10, a meander-shaped radiation part 654b extending from the coupling part 654a toward one end in the longitudinal direction (e.g., the Y-axis direction) of the antenna base material 652, and a meander-shaped radiation part 654c extending from the coupling part 654a toward the other end in the longitudinal direction.

In the case of the sixth embodiment, the coupling part 654a of the antenna conductor 654 has a semi-loop shape (e.g., a “C” shape) and is disposed on the antenna base material 652 to surround the RFID tag 10. Therefore, the RFID tag 10 is disposed on the antenna base material 652 in the semi-loop coupling part 654a and in a non-contact state with respect to the coupling part. As a result, the coupling part 654a of the antenna conductor 654 and the coil conductor 16 of the RFID tag 10 are coupled through an electromagnetic field so that the antenna conductor 654 can function as a booster antenna. As a result, the communication distance of the RFID tag 10 can be extended as compared to when the booster antenna 650 is not used. For example, the communication distance can be extended from several centimeters to several meters.

Additionally, since the RFID tag 10 is mounted on the antenna base material 652 via the side surface 12d of the substrate 12 having the largest area, the RFID tag 10 can firmly be fixed (e.g., can firmly be bonded) to the antenna base material 652 as compared to mounting via other side surfaces.

Furthermore, the RFID tag 10 is not in contact with the coupling part 654a of the antenna conductor 654. In other words, the RFID tag 10 does not partially overlap with the coupling part 654a. Therefore, the coupling part 654a of the antenna conductor 654 is prevented from being broken due to an edge of the RFID tag 10 (e.g., an edge between the side surface 12d and the side surface 12f of the substrate 12).

For example, if the RFID tag 610 with a booster antenna is attached to linen to be washed, the antenna base material 652 is variously deformed repeatedly during washing. In this case, if the RFID tag 10 partially overlaps with the coupling part 654a, the edge of the RFID tag 10 may contact the coupling part 654a many times, and consequently, the contact portion may be broken. Therefore, in some uses of the RFID tag, the RFID tag 10 is preferably not in contact with the coupling part 654a of the antenna conductor 654.

As shown in FIG. 10, both the antenna conductor 654 and the RFID tag 10 are disposed on one surface 652a of the antenna base material 652. Alternatively, even if either one is disposed on the other surface 652b, the coupling part 654a of the antenna conductor 654 and the coil conductor 16 of the RFID tag 10 can be coupled through an electromagnetic field.

The RFID tag provided according to the sixth embodiment is configured to perform wireless communication over a longer communication distance as a favorable communication characteristic.

### Seventh Exemplary Embodiment

A seventh embodiment also provides an RFID tag with a booster antenna as with the sixth embodiment described above. However, the seventh embodiment is different from the sixth embodiment described above in the coupling part of the antenna conductor of the booster antenna. Therefore, the seventh embodiment will be described mainly in terms of different points.

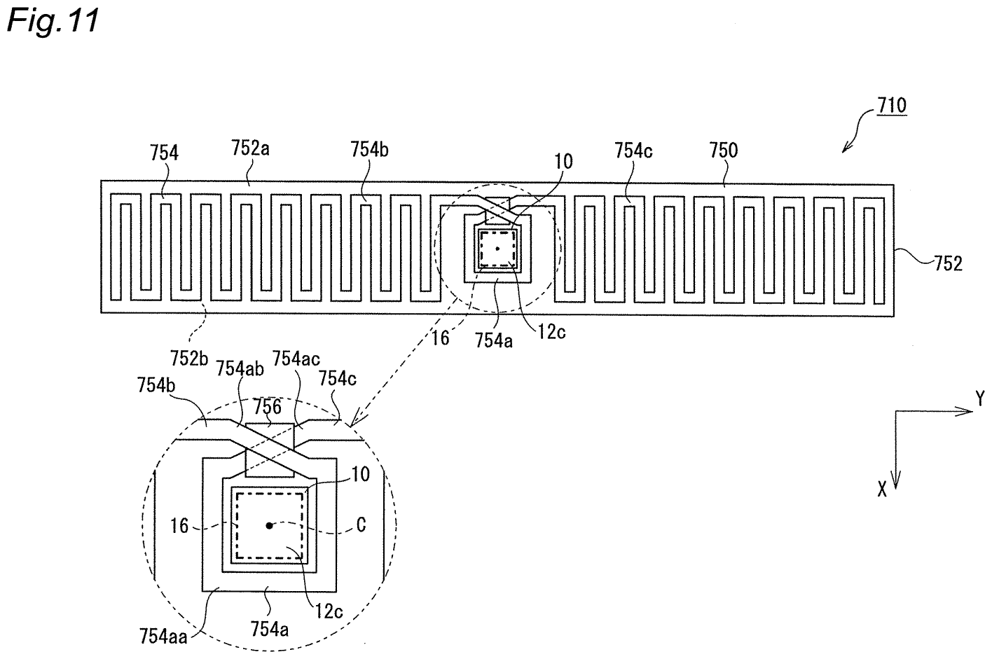

FIG. 11 is a plan view of an RFID tag with a booster antenna according to the seventh embodiment.

As shown in FIG. 11, an RFID tag 710 with a booster antenna according to the seventh embodiment has an RFID tag 10 and a booster antenna 750. The booster antenna 750 has an antenna base material 752 and an antenna conductor 754 as a conductor pattern disposed on the antenna base material 752. The antenna conductor 754 includes a coupling part 754a coupled through an electromagnetic field to the coil conductor 16 of the RFID tag 10, and radiation parts 754b, 754c respectively extending from the coupling part 754a.

In the seventh embodiment, the coupling part 754a of the antenna conductor 754 has a loop shape rather than a semi-loop shape. Specifically, in the coupling part 754a, one end part 754ab of the coupling part 754a connected to the one radiation part 754b three-dimensionally intersects with the other end part 754ac connected to the other radiation part 754c. A main body part 754aa between the two end parts 754ab, 754ac surrounds three sides of the RFID tag 10. An insulating layer 756 is disposed between the one end part 754ab and the other end part 754ac intersecting with each other.

The RFID tag 10 is disposed in the loop-shaped coupling part 754a. Therefore, the whole circumference of the RFID tag 10 is surrounded by the coupling part 754a. As a result, as compared to the semi-loop-shaped coupling part, the loop-shaped coupling part 754a is more strongly coupled through an electromagnetic field to the coil conductor 16 of the RFID tag 10. Consequently, the communication distance of the RFID tag 10 is further extended.

The RFID tag provided according to the seventh embodiment is configured to perform wireless communication over a longer communication distance as a favorable communication characteristic.

### Eighth Exemplary Embodiment

In an eighth embodiment, as in the seventh embodiment described above, the coupling part in the antenna conductor of the booster antenna has a loop shape. However, a form of electromagnetic field coupling between the coupling part of the antenna conductor and the coil conductor of the RFID tag is different from the seventh embodiment described above. Therefore, the eighth embodiment will be described mainly in terms of different points.

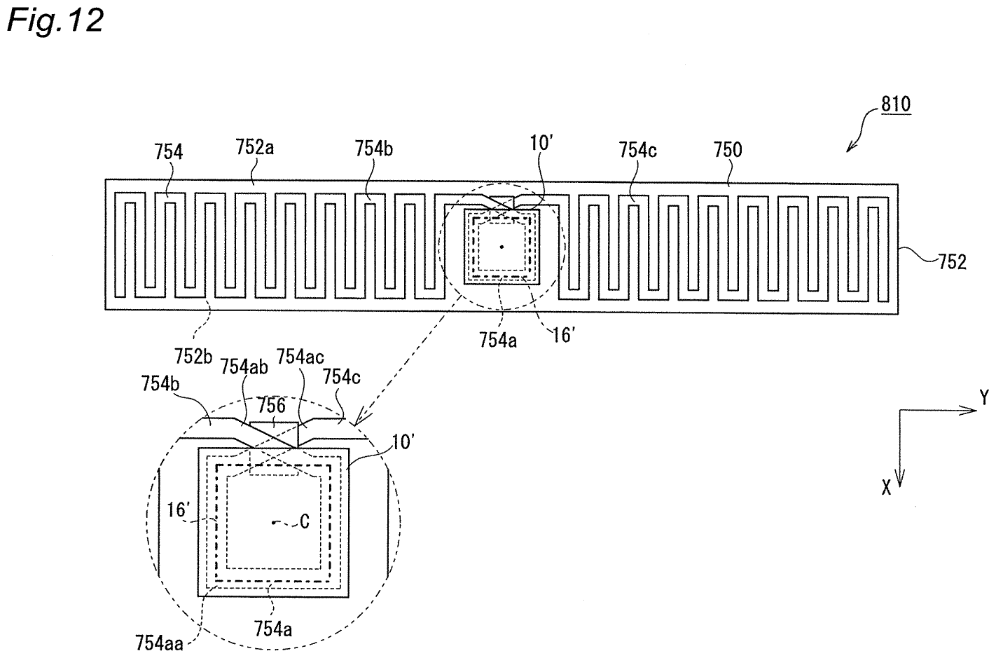

FIG. 12 is a plan view of an RFID tag with a booster antenna according to the eighth embodiment.

As shown in FIG. 12, an RFID tag 810 with a booster antenna according to the eighth embodiment has an RFID tag 10′ and the booster antenna 750 in the seventh embodiment described above.

The RFID tag 10′ has substantially the same structure as the RFID tag 10 in the seventh embodiment described above except that the overall size and the size of the coil conductor are different. Specifically, the overall size of the RFID tag 10′ is larger than that of the RFID tag 10, and the size of a coil conductor 16′ is larger than that of the coil conductor 16.

In the case of the seventh embodiment described above, as shown in FIG. 11, the RFID tag 10 is disposed in the loop-shaped coupling part 754a of the antenna conductor 754. In contrast, in the case of the eighth embodiment, the RFID tag 10′ is disposed on the antenna base material 752 so as to substantially cover the loop-shaped coupling part 754a of the antenna conductor 754.

Particularly, the RFID tag 10′ is disposed on the antenna base material 752 so that the coil conductor 16′ overlaps with the loop-shaped coupling part 754a (when viewed in the winding axis C direction (e.g., the Z-axis direction) of the coil conductor 16′).

Since the coil conductor 16′ of the RFID tag 10′ and the loop-shaped coupling part 754a of the antenna conductor 754 overlap in the winding axis C direction, the coil conductor 16′ and the coupling part 754a are more strongly coupled through an electromagnetic field (as compared to when the coupling part 754a surrounds the RFID tag 10 as in the seventh embodiment described above).

Additionally, the RFID tag 10′ overlaps with a portion of a three-dimensional intersection part (the one end part 754ab and the other end part 754ac) of the loop-shaped coupling part 754a. This improves the bending rigidity of the antenna base material 752 in a portion in which this three-dimensional intersection part exists so that the antenna base material 752 is prevented from bending in this portion. Consequently, the three-dimensional intersection part is prevented from being broken.

The RFID tag provided according to the eighth embodiment is configured to perform wireless communication over a longer communication distance as a favorable communication characteristic.

### Ninth Exemplary Embodiment

In a ninth embodiment, as in the seventh embodiment described above, the coupling part in the antenna conductor of the booster antenna has a loop shape. However, the structure of the antenna conductor for forming the loop is different from the seventh embodiment described above. Therefore, the ninth embodiment will be described mainly in terms of different points.

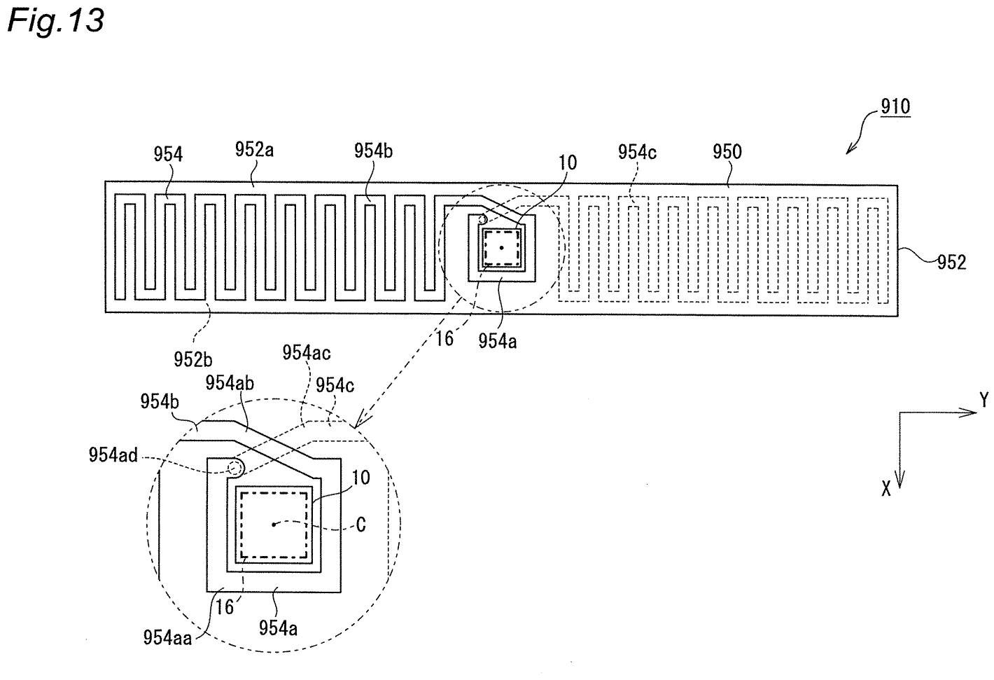

FIG. 13 is a plan view of an RFID tag with a booster antenna according to the ninth embodiment.

As shown in FIG. 13, an RFID tag 910 with a booster antenna according to the ninth embodiment has the RFID tag 10 and a booster antenna 950. The booster antenna 950 has an antenna base material 952 and an antenna conductor 954 as a conductor pattern disposed on the antenna base material 952. The antenna conductor 954 includes a coupling part 954a coupled through an electromagnetic field to the coil conductor 16 of the RFID tag 10, and radiation parts 954b, 954c respectively extending from the coupling part 954a.

In the case of the ninth embodiment, the one radiation part 954b of the antenna conductor 954 is disposed on one surface 952a of the antenna base material 952, and the other radiation part 954c is disposed on the other surface 952b. Therefore, an end part 954ac of the coupling part 954a connected to the other radiation part 954c is also disposed on the other surface 952b of the antenna base material 952. The end part 954ac disposed on the other surface 952b is connected via an interlayer connection conductor 954ad penetrating the antenna base material 952 to a main body part 954ac of the coupling part 954a disposed on the one surface 952a and surrounding three sides of the RFID tag 10.

The RFID tag 10 is disposed in the loop-shaped coupling part 954a as described above. Therefore, the whole circumference of the RFID tag 10 is surrounded by the coupling part 954a. As a result, as compared to the semi-loop-shaped coupling part, the loop-shaped coupling part 954a is more strongly coupled through an electromagnetic field to the coil conductor 16 of the RFID tag 10. Consequently, the communication distance of the RFID tag 10 is further extended.

The RFID tag provided according to the ninth embodiment is configured to perform wireless communication over a longer communication distance as a favorable communication characteristic.

### Tenth Exemplary Embodiment

In a tenth embodiment, as in the ninth embodiment described above, the coupling part in the antenna conductor of the booster antenna has a loop shape, and the two radiation parts are respectively disposed on different surfaces of the antenna base material. However, a form of electromagnetic field coupling between the coupling part of the antenna conductor and the coil conductor of the RFID tag is different from the ninth embodiment described above. Therefore, the tenth embodiment will be described mainly in terms of different points.

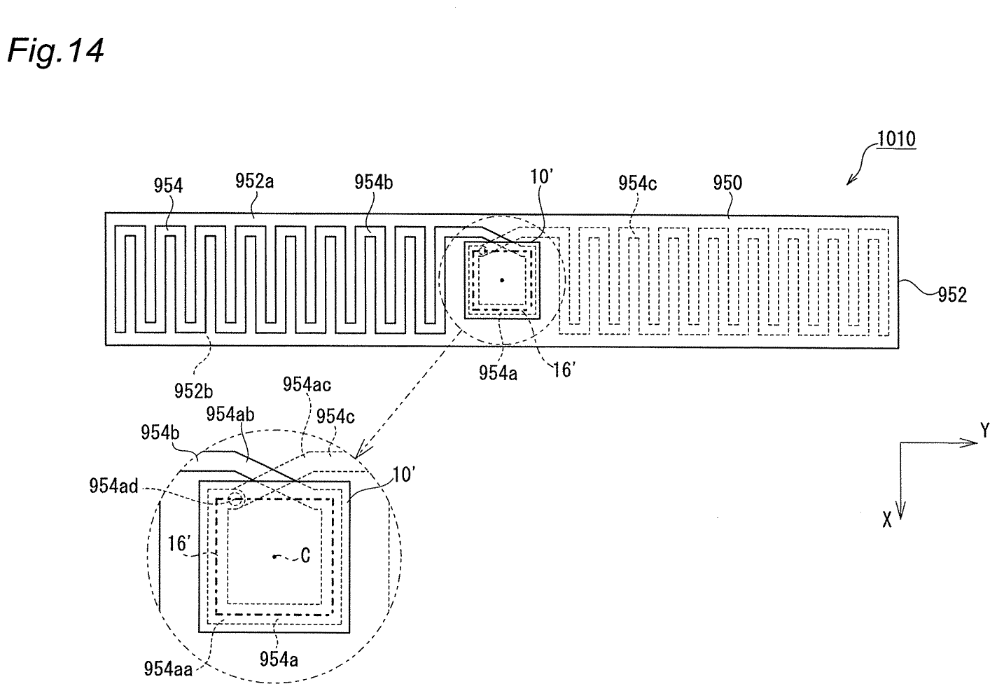

FIG. 14 is a plan view of an RFID tag with a booster antenna according to the tenth embodiment.

As shown in FIG. 14, an RFID tag 1010 with a booster antenna according to the tenth embodiment has the RFID tag 10′ and the booster antenna 950 of the ninth embodiment described above.

The RFID tag 10′ has substantially the same structure as the RFID tag 10 of the ninth embodiment described above except that the overall size and the size of the coil conductor are different. Specifically, the overall size of the RFID tag 10′ is larger than that of the RFID tag 10, and the size of the coil conductor 16′ is larger than that of the coil conductor 16.

In the case of the ninth embodiment described above, as shown in FIG. 13, the RFID tag 10 is disposed in the loop-shaped coupling part 954a of the antenna conductor 954. In contrast, in the case of the tenth embodiment, the RFID tag 10′ is disposed on the antenna base material 952 so as to substantially cover the loop-shaped coupling part 954a of the antenna conductor 954. Particularly, the RFID tag 10′ is disposed on the antenna base material 952 so that the coil conductor 16′ overlaps with the loop-shaped coupling part 754a (when viewed in the winding axis C direction (e.g., the Z-axis direction) of the coil conductor 16′).

Since the coil conductor 16′ of the RFID tag 10′ and the loop-shaped coupling part 954a of the antenna conductor 954 overlap in the winding axis C direction, the coil conductor 16′ and the coupling part 954a are more strongly coupled through an electromagnetic field (as compared to when the coupling part 954a surrounds the RFID tag 10 as in the ninth embodiment described above).

Also, the RFID tag 10′ overlaps with the interlayer connection conductor 954ad in the loop-shaped coupling part 954a. This improves the bending rigidity of the antenna base material 952 in a portion in which this interlayer connection conductor 954ad exists so that the antenna base material 952 is prevented from bending in this portion. Consequently, the interlayer connection conductor 954ad and the main body part 954aa of the coupling part 954a are prevented from being disconnected, and the interlayer connection conductor 954ad and the end part 954ac of the coupling part 954a are prevented from being disconnected.

The RFID tag provided according to the tenth embodiment is configured to perform wireless communication over a longer communication distance as a favorable communication characteristic.

### Eleventh Exemplary Embodiment

In an eleventh embodiment, as in the seventh and ninth embodiments described above, the coupling part in the antenna conductor of the booster antenna has a loop shape. However, the structure of the antenna conductor for forming the loop is different from the seventh and ninth embodiments described above. Therefore, the eleventh embodiment will be described mainly in terms of different points.

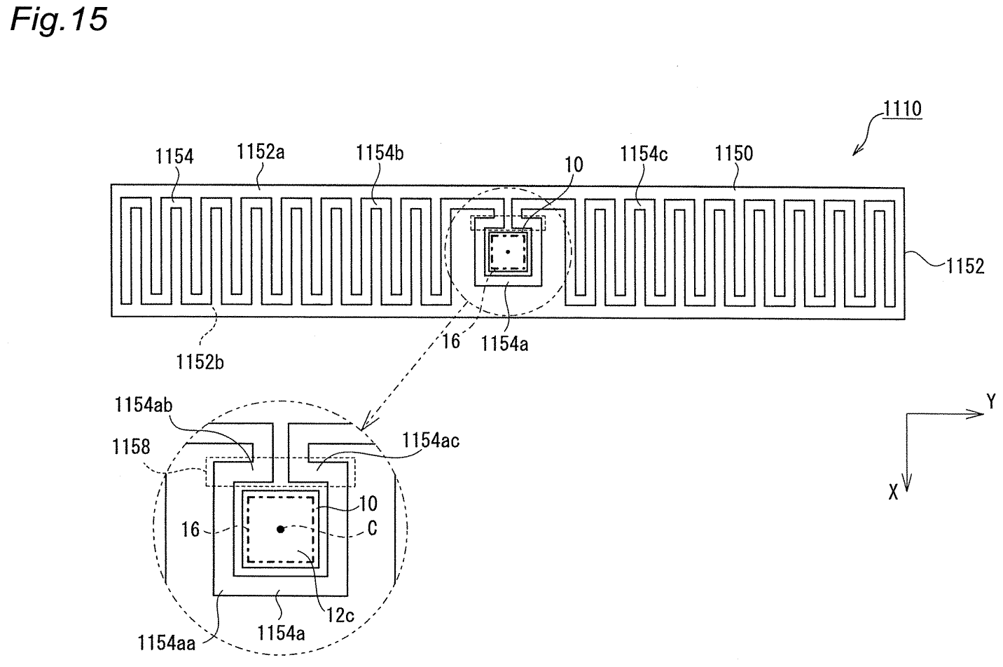

FIG. 15 is a plan view of an RFID tag with a booster antenna according to the eleventh embodiment.

As shown in FIG. 15, an RFID tag 1110 with a booster antenna according to the eleventh embodiment has the RFID tag 10 and a booster antenna 1150. The booster antenna 1150 has an antenna base material 1152 and an antenna conductor 1154 as a conductor pattern disposed on the antenna base material 1152. The antenna conductor 1154 includes a coupling part 1154a coupled through an electromagnetic field to the coil conductor 16 of the RFID tag 10, and radiation parts 1154b, 1154c respectively extending from the coupling part 1154a.

The coupling part 1154a in the antenna conductor 1154 of the eleventh embodiment has a loop shape. Specifically, the loop shape is formed by a semi-loop-shaped main body part 1154aa disposed on one surface 1152a of the antenna base material 1152 and a band-shaped capacitance-forming conductor 1158 disposed on the other surface 1152b.

As shown in FIG. 15, the band-shaped capacitance-forming conductor 1158 has one end capacitively coupled to one end 1154ab of the semi-loop main body part 1154aa and the other end capacitively coupled to the other end 1154ac of the main body part 1154aa. A loop-shaped coupling part 1154a is made up of the main body part 1154aa and the capacitance-forming conductor 1158 as described above.

Even the non-continuous loop-shaped coupling part 1154a as described above can be coupled through an electromagnetic field to the coil conductor 16 of the RFID tag 10.

Additionally, the loop-shaped coupling part 1154a is formed without the three-dimensional intersection of the antenna conductor as shown in FIG. 11 and without using the interlayer connection conductor 954ad as shown in FIG. 13. Therefore, even when the antenna base material 1152 is repeatedly deformed, the coupling part 1154a of the antenna conductor 1154 according to the eleventh embodiment is hardly broken, due to the structure without the three-dimensional crossing part or the interlayer connection conductor.

Furthermore, in the case of the RFID tag 1110 with a booster antenna shown in FIG. 15, the RFID tag 10 is disposed in the loop-shaped coupling part 1154a, so that the coupling part 1154a of the antenna conductor 1154 is further prevented from being broken. Consequently, even if the antenna base material 1152 is repeatedly deformed more significantly for a longer time, the RFID tag 1110 with a booster antenna can continuously maintain a communication performance.

By appropriately setting the length of the capacitance-forming conductor 1158 and the area facing the coupling part 1154a, the antenna conductor 1154 can have a resonance frequency substantially identical to the resonance frequency of the RFID tag 10. As a result, the coupling part 1154a of the antenna conductor 1154 and the coil conductor 16 of the RFID tag 10 can more strongly be coupled through an electromagnetic field due to having a substantially equal resonance frequency. Consequently, the communication distance of the RFID tag 1110 can further be extended.

The RFID tag provided according to the eleventh embodiment is configured to wireless communication over a longer communication distance as a favorable communication characteristic.

### Twelfth Exemplary Embodiment

In the case of the sixth to eleventh embodiments described above, the antenna conductor of the booster antenna is a conductor pattern disposed on an antenna base material made of a resin sheet. However, exemplary embodiments of the present invention are not limited thereto.

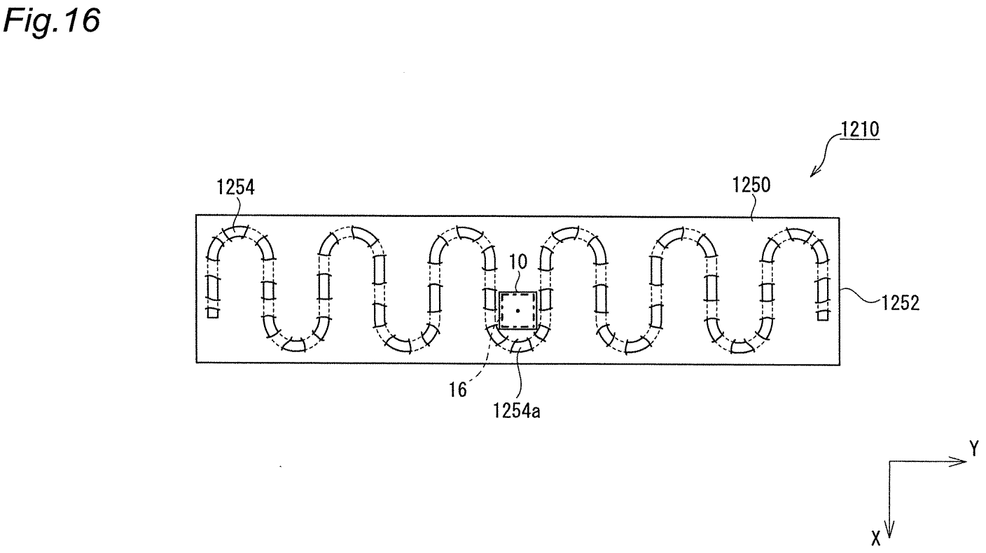

FIGS. 16 to 18 are plan views of RFID tags with booster antennas of different examples according to a twelfth embodiment.

In the case of an RFID tag 1210 with a booster antenna of an example shown in FIG. 16, an antenna base material 1252 of a booster antenna 1250 is a cloth member, and an antenna conductor 1254 is a conducting wire such as a metal wire sewn to the antenna base material 1252. In the RFID antenna 1210 with a booster antenna shown in FIG. 16, the antenna conductor 1254 is sewn to the antenna base material 1252 in a meander shape. A folded part 1254a of the antenna conductor 1254 functions as a coupling part coupled through an electromagnetic field to the coil conductor 16 of the RFID tag 10.

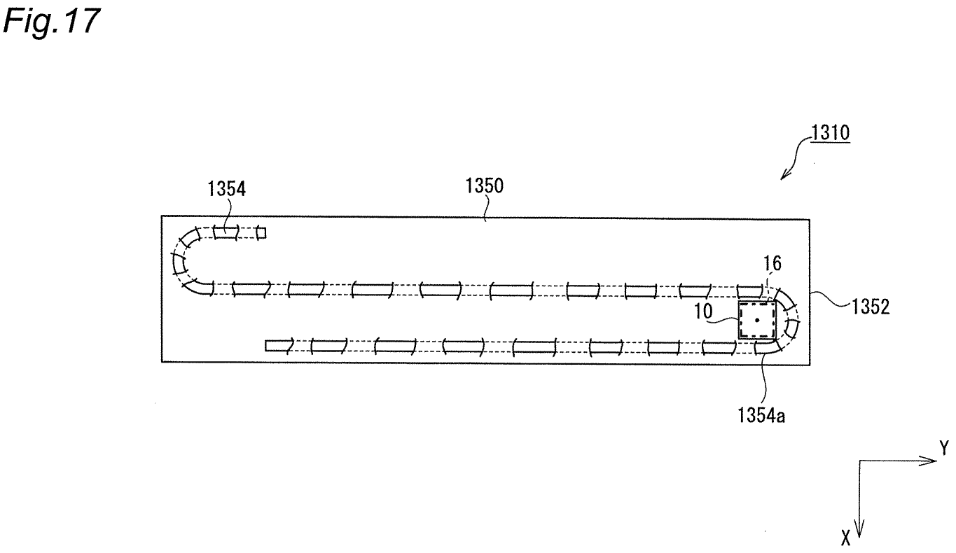

In the case of an RFID tag 1310 with a booster antenna of another example shown in FIG. 17, an antenna conductor 1354 of a booster antenna 1350 is sewn to the antenna base material 1352 in an S shape. A folded part 1354a of the antenna conductor 1354 functions as a coupling part coupled through an electromagnetic field to the coil conductor 16 of the RFID tag 10.

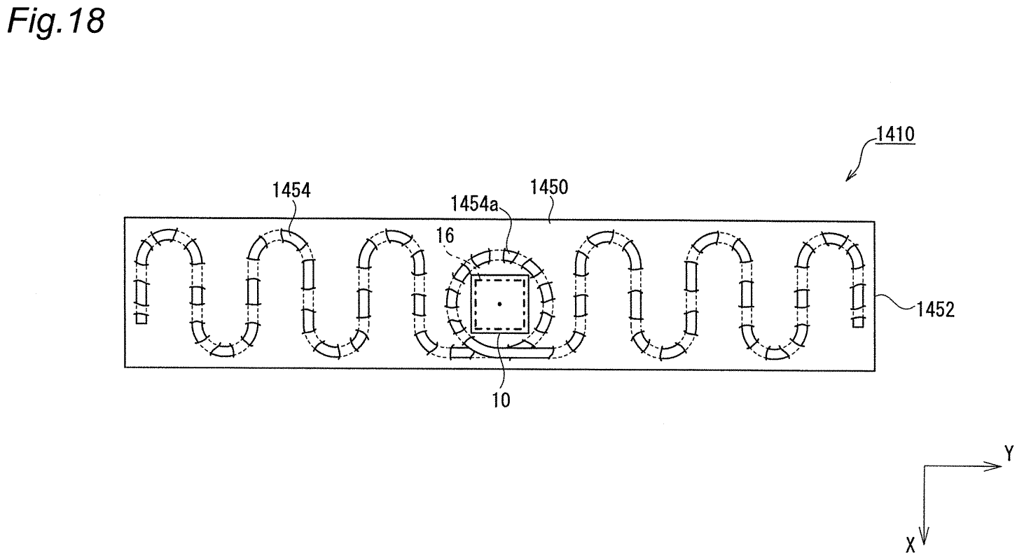

In the case of a RFID tag 1410 with a booster antenna of a further example shown in FIG. 18, an antenna conductor 1454 of a booster antenna 1450 is sewn to an antenna base material 1452 in a meander shape such that one loop part 1454a is formed. The loop part 1454a functions as a coupling part coupled through an electromagnetic field to the coil conductor 16 of the RFID tag 10.

As described above, by forming the antenna base material by the cloth member and sewing the conducting wire as the antenna conductor to the antenna base material, a freely deformable RFID tag with a booster antenna can be formed. Therefore, the RFID tag with a booster antenna hardly broken by deformation can be achieved.

The RFID tag provided according to the twelfth embodiment is configured to perform wireless communication over a longer communication distance as a favorable communication characteristic.

It is noted that although the present invention has been described with reference to the first to twelfth embodiments, the embodiments of the present invention are not limited thereto.

For example, in the case of the third embodiment described above, as shown in FIG. 6, the coil conductor of the RFID tag is made up of two loops; however, the coil conductor may be made up of three or more loops. In the case of the first embodiment describe above, as shown in FIG. 1, the protective layers protecting the RFIC chip and the conductor pattern are disposed; however, the protective layers may not be included in some cases. For example, if the RFID tag is embedded and used in a resin article, the protective layer may not be included since the RFIC chip etc. are protected by the resin article.

It should be apparent for those skilled in the art that at least one embodiment can entirely or partially be combined with a certain exemplary embodiment to form a further embodiment according to the present invention.

Furthermore, the RFID tag of the exemplary embodiments according to the present invention can be attached to various articles when used. The RFID tag can be attached to a metal body such as a metal plate or a metal portion of an article, i.e., a metal surface, when used. In this case, the RFID tag can use a metal surface as a radiator. If a metal surface is used as a radiator, the RFID tag is Preferably attached to the metal surface such that a coil opening plane of the coil conductor of the RFID tag is approximately perpendicular to the metal surface, i.e., the winding axis of the coil conductor is approximately parallel to the metal surface.

Specifically, in a broad sense, the RFID tag of the embodiments according to the present invention is an RFID tag comprising: a rectangular parallelepiped substrate including a top surface, a bottom surface, and four side surfaces; an RFIC chip mounted on the top surface of the substrate; and a coil conductor disposed on the substrate and connected to the RFIC chip, wherein the coil conductor includes a conductor pattern disposed on the top surface, a conductor pattern disposed on the bottom surface, and a plurality of through-hole conductors penetrating the substrate and extending between the top surface and the bottom surface. Moreover, a winding axis of the coil conductor intersects with each of paired side surfaces opposite to each other and having a largest area among the four side surfaces.

In a broad sense, a method of manufacturing the RFID tag of the embodiments according to the present invention is a method of manufacturing an RFID tag comprising preparing a collective substrate including a principal surface and a back surface at both ends in a thickness direction and including a plurality of rectangular parallelepiped child substrate regions; forming a conductor pattern on a principal surface portion of each of the child substrate regions; forming a conductor pattern on a back surface portion of each of the child substrate regions; forming a plurality of through-holes penetrating the collective substrate in the thickness direction and extending between the principal surface and the back surface in each of the child substrate regions; disposing a plurality of through-hole conductors by forming conductor layers on inner surfaces of the plurality of through-holes, and thereby forming a coil conductor including the respective conductor patterns of the principal surface portion and the back surface portion and the plurality of through-hole conductors, in each of the child substrate regions; mounting an RFIC chip connected to the coil conductor on the principal surface portion of each of the child substrate regions; and producing a plurality of rectangular parallelepiped RFID tags by cutting the collective substrate along boundaries of the plurality of child substrate regions. In the exemplary aspect, the collective substrate is cut such that a winding axis of the coil conductor intersects with each of paired cutting surfaces opposite to each other and having a largest area among four cutting surfaces of the RFID tag.

### EXPLANATIONS OF LETTERS OR NUMERALS

10 RFID tag
12 substrate
12a top surface
12b bottom surface
12c side surface
12d side surface
12e side surface
12f side surface
14 RFIC chip
16 coil conductor
20 conductor pattern (top-surface conductor pattern)
22 conductor pattern (bottom-surface conductor pattern)
24 through-hole conductor
26 through-hole conductor
C winding axis

1. An RFID tag comprising:
a rectangular parallelepiped substrate that includes a top surface, a bottom surface, and four side surfaces disposed between the top and bottoms surfaces;
an RFIC chip disposed on the top surface of the substrate; and
a coil conductor connected to the RFIC chip and including a conductor pattern disposed on the top surface, a conductor pattern disposed on the bottom surface, and a plurality of through-hole conductors penetrating the substrate and extending between the top and bottom surfaces of the substrate,
wherein the coil conductor comprises a winding axis that intersects with a pair of the side surfaces opposite to each other and having a largest surface area among the four side surfaces.

2. The RFID tag according to claim 1, wherein the pair of side surfaces intersected by the winding axis of the coil conductor has a larger surface area than that of each of the top surface and the bottom surface of the substrate.

3. The RFID tag according to claim 1, further comprising a first protective layer disposed on the top surface of the substrate to cover the RFIC chip and the conductor pattern.

4. The RFID tag according to claim 3, further comprising a second protective layer disposed on the bottom surface of the substrate to cover the conductor pattern.

5. The RFID tag according to claim 4, wherein the first and second protective layers are resin layers of a same resin material, and the RFID tag includes resin connection bodies of the same resin material that extend in the through-hole conductors to connect the first protective layer to the second protective layer.

6. The RFID tag according to claim 1, wherein the coil conductor comprises at least two loops so that the plurality of through-hole conductors comprises at least four through-hole conductors.

7. The RFID tag according to claim 6, wherein the plurality of through-hole conductors included in one loop overlap with the plurality of through-hole conductors included in a second loop that is adjacent to the one loop when viewed in an opposing direction of a pair of the side surfaces different from the pair of the side surfaces of the substrate that are intersected by the winding axis of the coil conductor.

8. The RFID tag according to claim 1, wherein the substrate comprises a glass epoxy substrate.

9. The RFID tag according to claim 1, further comprising a booster antenna that includes a sheet-shaped antenna base material on which the RFID tag is disposed via one of the pair of side surfaces intersected by the winding axis of the coil conductor, and an antenna conductor disposed on the antenna base material and including a coupling part coupled through an electromagnetic field to the coil conductor and a radiation part extending from the coupling part.

10. The RFID tag according to claim 9, wherein the coupling part of the antenna conductor is loop-shaped or semi-loop-shaped.

11. The RFID tag according to claim 10, wherein the coil conductor is disposed in the loop-shaped or semi-loop-shaped coupling part.

12. The RFID tag according to claim 10, wherein the RFID tag is disposed on the antenna base material so that the coil conductor overlaps with the loop-shaped or semi-loop-shaped coupling part.

13. The RFID tag according to claim 9, wherein the coupling part of the antenna conductor comprises a semi-loop-shaped conductor that is disposed on a first surface of the antenna base material and a capacitance-forming conductor disposed on a second surface of the antenna base material that opposes the first surface, such that the capacitance-forming conductor is capacitively coupled to opposing ends of the semi-loop-shaped conductor.

14. The RFID tag according to claim 9, wherein the antenna base material comprises a cloth member, and the antenna conductor comprises a conducting wire sewn to the cloth member.

15. A method of manufacturing an RFID tag comprising:
preparing a collective substrate that includes a principal surface and a back surface at both ends in a thickness direction and further includes a plurality of rectangular parallelepiped child substrate regions;
forming a conductor pattern on a principal surface of each of the plurality of child substrate regions;
forming a conductor pattern on a back surface of each of the plurality of child substrate regions;
forming a plurality of through-holes that penetrate the collective substrate in the thickness direction and extend between the principal surface and the back surface in each of the plurality of child substrate regions;
disposing a plurality of through-hole conductors by forming conductor layers on inner surfaces of each of the plurality of through-holes to form a coil conductor that includes the respective conductor patterns of the principal surfaces and the back surfaces and the plurality of through-hole conductors;
mounting an RFIC chip connected to the coil conductor on the principal surface of each of the plurality of child substrate regions; and
producing a plurality of rectangular parallelepiped RFID tags by cutting the collective substrate along boundaries of the plurality of child substrate regions,
wherein the cutting of the collective substrate comprises cutting the collective substrate such that a winding axis of the coil conductor intersects with each of paired cutting surfaces opposite to each other and having a largest area among four cutting surfaces of the RFID tag.

16. The method of manufacturing an RFID tag according to claim 15, further comprising forming a first protective layer on the principal surface of each of the plurality of child substrate regions to cover the RFIC chip and the conductor pattern.

17. The method of manufacturing an RFID tag according to claim 16, further comprising forming a second protective layer disposed on the back surface of each of the plurality of child substrate regions to cover the conductor pattern.

18. The method of manufacturing an RFID tag according to claim 17, further comprising forming the first and second protective layers as resin layers of a same resin material, and forming the RFID tag to include resin connection bodies of the same resin material that extend in the plurality of through-hole conductors to connect the first protective layer to the second protective layer.

19. The method of manufacturing an RFID tag according claim 15, further comprising forming the coil conductor to include at least two loops so that the plurality of through-hole conductors comprises at least four through-hole conductors.

20. The method of manufacturing an RFID tag according claim 19, further comprising forming the plurality of through-hole conductors included in one loop to overlap with the plurality of through-hole conductors included in a second loop that is adjacent to the one loop.
